(19) United States
(12) Patent Application Publication
(10) Pub. No.: US 2026/0215381 A1
(43) Pub. Date: Jul. 30, 2026

(54) HYDROPONIC PLANT PRODUCTION SYSTEM

(71) Applicant: FRUGALTEC AG, Diepoldsau (CH)

(72) Inventors: Sascha ROHNER, Diepoldsau (CH); Paul OEHY, Diepoldsau (CH)

(73) Assignee: FRUGALTEC AG, Diepoldsau (CH)

(21) Appl. No.: 19/141,084

(22) PCT Filed: Dec. 28, 2022
(86) PCT No.: PCT/EP2022/087972

§ 371 Date: Jun. 19, 2025

(51) Int. Cl. A01G 31/06

(52) U.S. Cl. CPC A01G 31/06

(57) ABSTRACT

A hydroponic plant production system comprises: a base part, a head part, a support structure comprising at least two carrier elements, wherein the carrier elements are individually removably arranged between the base part and the head part and each comprise at least a first part of a fastening mechanism for attaching at least one plant holder, and at least one plant holder comprising a second part of the fastening mechanism for attaching the plant holder to a carrier element such that the plant holder is individually removably attached to the carrier element by interaction between the first part and the second part of the fastening mechanism. The invention also relates to a plant holder and a carrier element.

### CROSS REFERENCE TO RELATED APPLICATIONS

This application is a national stage entry of International Application No. PCT/EP2022/087972, filed on Dec. 28, 2022, the entire contents of which are incorporated herein by reference.

### TECHNICAL FIELD

The invention relates to a hydroponic plant production system comprising a base part, a head part, a support structure and at least one plant holder. The invention also relates to a plant holder and a carrier element.

### BACKGROUND

The hydroponic plant production systems known from the prior art are usually designed in such a way that, if set up, they can only be dismantled or redesigned with great effort. Furthermore, the hydroponic plant production systems known from the prior art often produce undesirable splashing noises, which can be caused by poorly controlled fluid movements in the hydroponic plant production system. The hydroponic plant production systems known from the prior art may furthermore have problems concerning heating of an interior space and the water circulating therein, wherein excessive heating, in particular caused by sunlight shining on the plant production system, may contribute to an impairment of plant growth and to an increased risk for the formation of undesirable microorganisms. Another problem with the hydroponic plant production systems known from the prior art is the occurrence of mold in some poorly ventilated areas of the plant production system that come into contact with liquid.

### SUMMARY

The object of the invention is to provide a hydroponic plant production system which eliminates at least some of the disadvantages of the hydroponic plant production systems known from the prior art.

According to a first aspect of the present invention, the invention relates to a hydroponic plant production system comprising: (i) a base part, (ii) a head part, (iii) a support structure comprising at least two carrier elements, wherein the carrier elements are individually removably arranged between the base part and the head part and each comprise at least a first part of a fastening mechanism for attaching at least one plant holder, and (iv) at least one plant holder comprising a second part of the fastening mechanism for attaching the plant holder to a carrier element such that the plant holder is individually removably attached to the carrier element by interaction between the first part and the second part of the fastening mechanism.

A hydroponic plant production system according to the invention can be used for the cultivation of useful plants, in particular for fruit and vegetable production, for the cultivation of medicinal plants, for rooting cuttings, for the cultivation of ornamental plants or for the cultivation of edible mushrooms. Plant holders of a hydroponic plant production system according to the invention are designed to receive plants, wherein the plant holder can be designed in such a way that a supporting substrate, into which a plant can be inserted, can be introduced into the plant holder. Alternatively, the plant holder can also be designed so that a plant can be placed in the plant holder without an additional supporting substrate.

A hydroponic plant production system according to the invention has a modular design and enables a flexible configuration, in particular with regard to a height of the hydroponic plant production system by selecting carrier elements with desired extensions and with regard to distances between the plant holders. In contrast to the hydroponic plant production systems known from the prior art, individually removable carrier elements and individually removable plant holders, which are attached to the carrier elements, of a plant production system according to the invention furthermore enable simple assembly, disassembly and conversion of the plant production system according to the invention. Plants can, for example, be inserted into a plant holder that is not yet attached to a carrier element and is only attached to the carrier element after a plant has been inserted: this can sometimes simplify insertion, as it is easier to position a plant holder advantageously for inserting a plant in the case of a plant holder that is not yet attached to a carrier element than in the case of a plant holder that is already attached to a carrier element, as in the latter case the carrier element must also be positioned. For harvesting plants, in turn, it can be advantageous to first remove carrier elements with plant holders attached to them individually from the plant production system according to the invention and then position them in such a way that harvesting can be carried out in a simplified and automated manner. Furthermore, the carrier elements of a plant production system according to the invention can also be easily replaced by other carrier elements to which a different number of plant holders can be attached.

The first fastening mechanism and the second fastening mechanism are designed in such a way that their interaction results in a fastening mechanism that fastens a plant holder to a carrier element. The first and second fastening mechanisms are designed in particular so that a plant holder fastened to a carrier element can be removed from the latter individually.

In one embodiment of the hydroponic plant production system according to the first aspect of the present invention, the support structure is configured as a tower-like structure.

In a further embodiment of the hydroponic plant production system according to the first aspect of the present invention, the support structure has eight carrier elements and a substantially octagonal base surface.

In a further embodiment of the hydroponic plant production system according to the first aspect of the present invention, the carrier elements extend continuously from the base part to the head part.

Alternatively, at least one intermediate part may be arranged between the base part and the head part, wherein the carrier elements do not extend continuously from the base part to the head part: in the case of a hydroponic plant production system with a base part, an intermediate part and a head part, for example, a first part of the carrier elements may extend continuously from the base part to the intermediate part and a second part of the carrier elements may extend continuously from the intermediate part to the head part. The hydroponic plant production systems can generally have more than one intermediate part. Advantageously, this makes it easy to configure the height of the hydroponic plant production system.

In a further embodiment of the hydroponic plant production system according to the first aspect of the present invention, the plant holder comprises a liquid depot.

A plant placed in the plant holder can draw nutrients, water and oxygen from the liquid in the liquid depot.

In a further embodiment of the hydroponic plant production system according to the first aspect of the present invention, the carrier elements are each panel-shaped and have at least one cavity, wherein the at least one cavity extends continuously along a longitudinal axis, which in particular extends from the base part to the head part, of the respective panel-shaped carrier element.

Due to the cavity, the carrier elements can be lighter than comparable carrier elements without a cavity, wherein a reduced weight can simplify the assembly, disassembly and conversion of the hydroponic plant production system according to the invention. The carrier elements can preferably be panel-shaped, i.e. essentially flat cuboid with a significantly greater length and width than depth, wherein the longitudinal direction of the support elements can extend between the head part and the base part. At least one cavity can also serve as an insulator and thermally shield an interior area from an exterior area on which, for example, sunlight shines, thereby reducing heating of a liquid circulating in the interior area.

In a further embodiment of the hydroponic plant production system according to the first aspect of the present invention, the panel-shaped carrier elements each have at least two separated cavities.

In a further embodiment of the hydroponic plant production system according to the first aspect of the present invention, an insulating material is arranged within a first cavity of the separated cavities of at least one panel-shaped support element, and/or the first cavity is configured for supplying a gas to the plant holder.

An insulating material arranged in a cavity of the panel-shaped carrier element, for example a thermally insulating foam, can help to thermally insulate one side of the carrier element from an opposite side. In the case of a tower-like structure of the hydroponic plant production system, inner and outer sides can be defined that result directly from the design of the tower-like structure. Liquids flowing on the inner sides facing the inside of the tower-like structure can thus be at least partially protected from heating, which can be caused, for example, by sunlight shining on the outer sides of the tower-like structure: this can provide more stable conditions for optimum plant growth. Furthermore, the cavities can advantageously be used to feed gases, in particular carbon dioxide, to the plant holders attached to the carrier element in order to accelerate plant growth. Gases can be conducted through a cavity that also has some insulating material, or alternatively through a cavity without insulating material. A cavity can also be used for thermal insulation only and be completely filled with insulating foam so that no gas is conducted through such a cavity.

In a further embodiment of the hydroponic plant production system according to the first aspect of the present invention, a first panel-shaped carrier element and a second panel-shaped carrier element of the panel-shaped carrier elements each have at least two sealing lips extending completely along the longitudinal axis, wherein the at least two sealing lips of the first and second panel-shaped carrier elements adjoin one another at a sealing gap and are spaced apart from one another in such a way that only gaseous media, in particular air, can flow through the sealing gap.

The panel-shaped carrier elements can be designed such that they have two sides that are essentially parallel to each other, which in the case of a tower-like structure of the hydroponic plant production system each form an inner and an outer side, and two sloping sides that connect the two essentially parallel sides to each other. In particular, the inner side of a panel-shaped carrier element can have a smaller width than the corresponding outer side. The panel-shaped support elements can each be constructed symmetrically around a central plane that runs along a longitudinal direction of the carrier element. In the case of a tower-like structure of the plant production system, the longitudinal direction of the carrier element can correspond to the longitudinal direction of the plant production system, i.e. it can extend between the base part and the head part. The width of the inner and outer sides and, based on this, the angles between the inner and outer sides and the two sloping sides, can be designed in such a way that panel-shaped carrier elements closely adjoining each other on the sloping sides form a tower-like structure on a polygon-like base surface, wherein the base surface can be designed in particular as an octagon in the case of eight panel-shaped carrier elements.

The sealing lips, in particular multi-stage sealing lips, can be used to prevent, for example, a liquid, in particular splash water, flowing along the inside of a panel-shaped carrier element from entering the interface between two closely adjoining panel-shaped carrier elements and causing moisture and mold problems there. The sealing lips can be provided in the area of each of the two sloping sides of the panel-shaped carrier element, wherein the sealing lips of a panel-shaped carrier element interact with the corresponding sealing lips of an adjacent panel-shaped carrier element to achieve a sealing effect. A sealing lip in the area of a first sloping side of a panel-shaped carrier element can be bent in such a way that it adjoins a correspondingly bent sealing lip on a second sloping side of an adjacent panel-shaped carrier element in the area of a sealing gap and, together with the adjacent sealing lip, forms a sealing chamber that is spatially separated from the interface. These two bent sealing lips can be designed so that a sealing plane running centrally through the sealing gap encompasses the interface, i.e. the interface and the corresponding sealing gap can lie essentially in a common plane. The sealing gap can preferably be dimensioned in such a way that liquids are predominantly prevented from flowing through and as little light as possible can penetrate the sealing chamber, whereas gases, in particular air, can flow through the sealing gap: this can further prevent the occurrence of mold growth and the formation of algae in the area of the interfaces. The two bent sealing lips of adjacent panel-shaped carrier elements can therefore be slightly spaced apart from each other in the area of the sealing gap, i.e. they do not lie close together.

The sealing lips can be formed from the same material as the rest of the panel-shaped carrier element, which can be formed in particular as an extrusion part, whereby the sealing lips can have a long service life, especially since the sealing lips do not touch each other directly. This can further simplify the assembly, disassembly or conversion of the hydroponic plant production system, as no additional sealing lips, in particular no soft sealing lips, have to be used, which are not part of the carrier element but have to be mounted separately. Alternatively, the sealing lips can also be made of a soft material.

In an alternative embodiment of the hydroponic plant production system according to the first aspect of the present invention, a panel-shaped carrier element has only one sealing lip extending completely along the longitudinal axis. Such a carrier element with only one sealing lip can, for example, be mounted on a wall, wherein the one sealing lip of the carrier element can be located on the area of the carrier element facing away from the wall: in the area facing away from the wall, such a carrier element with only one sealing lip can then in turn be contacted by a carrier element with, for example, two sealing lips. At least two sealing lips can generally also be distributed asymmetrically with respect to the panel-shaped carrier element. For example, two sealing lips can be arranged at one end of the carrier element, which together with two sealing lips of an adjacent carrier element form two sealing chambers, and no sealing lip can be arranged at the other end of the carrier element, which is connected to a wall, for example.

In a further embodiment of the hydroponic plant production system according to the first aspect of the present invention, the panel-shaped carrier elements each have a fluid flow contour on one side, in particular aligned with an interior of the tower-like structure.

A liquid, in particular water and nutrients for plants in the plant holders, can, in the case of a tower-like structure, be guided from the head part to the base part on the inside of the panel-shaped carrier elements. Each panel-shaped carrier element can have a fluid flow contour for this purpose, in particular designed as two parallel ribs that extend along a longitudinal direction of the panel-shaped carrier element. The fluid flow contour enables a controlled flow of fluid along the inside of a panel-shaped carrier element.

In a further embodiment of the hydroponic plant production system according to the first aspect of the present invention, the head part has a distribution device which is designed to guide the liquid to the carrier elements, in particular to the sides of the carrier elements with fluid flow contour.

In a further embodiment of the hydroponic plant production system according to the first aspect of the present invention, the distribution device has funnel-like feed lines to the carrier elements that slope down from a center point.

In the case of a construction of the hydroponic plant production system as a tower-like structure, the distribution device can be arranged centrally, i.e. in the interior of the tower-like structure; the center of the distribution device can in particular be located on a main axis of the tower-like structure. The number of feed lines can correspond to the number of carrier elements, in particular panel-shaped carrier elements. An advantage of the feed lines sloping down from the center point is that despite a possible slight tilt, for example in the range of up to 5° (the exact angle can generally depend on the specific design of the distribution device and can also be greater than 5° depending on the design), the tower-like structure can still be guided to the sides of the carrier elements with fluid flow contour solely due to the effect of gravity. This makes it easier to set up the hydroponic plant production system, as certain tolerances in positioning are essentially harmless for the operation of the plant production system. The funnel-like structure of the feed lines can in turn ensure that the liquid is guided over a wide area and at a reduced speed to the sides of the carrier elements with fluid flow contour when the liquid volume is increased.

In a further embodiment of the hydroponic plant production system according to the first aspect of the present invention, the support structure comprises additional support elements.

Additional support elements can contribute to improved stability of the hydroponic plant production system.

In a further embodiment of the hydroponic plant production system according to the first aspect of the present invention, the base part comprises a collapsible tank adapted to receive and store the liquid, and a pump in the base part and a feed pipe, in particular centrally located in the tower-like structure and forming part of the additional support elements, are adapted to feed the liquid from the tank to the distribution device.

A collapsible tank can be easily stowed and shipped to save space when disassembling or converting the hydroponic plant production system. The collapsible tank can form a reservoir in which liquid, in particular water with additional nutrients, can be present. A pump in the base part, in turn, can convey the liquid from the collapsible tank to the distribution device in the head part through the feed pipe, which can form an additional support element and on which an additional support mechanism can be arranged, which connects the carrier elements indirectly to the feed pipe. A nozzle can be arranged at the transition between the feed pipe and the distribution device, which can guide the fluid flowing through the feed pipe evenly to the feed lines of the distribution device.

In a further embodiment of the hydroponic plant production system according to the first aspect of the present invention, the fastening mechanism is configured such that an excess fluid in the fluid depot is dischargeable through at least one opening of the attached plant holder to the side of the fluid flow contour carrier element.

The plant holder and carrier element as well as the corresponding fastening mechanism can be designed so that liquid flowing along the fluid flow contour enters the attached plant holder in such a way that it first flows in the direction of the liquid depot; as soon as this is filled, new liquid flowing in the direction of the plant holder as well as liquid already present in the liquid depot can partially leave the plant holder through at least one opening and flow via the part of the carrier element located below the plant holder in the direction of a further plant holder and/or in the direction of the base part. Drainage through at least one opening, which is located in the attached plant holder near the side of the carrier element with fluid flow contour, enables controlled drainage without strong noise formation. At least one opening allows a constant exchange of liquid in the liquid depot, as liquid flowing in can gradually replace liquid present in the liquid depot. The plant holder can be attached to the carrier element by means of the fastening mechanism in such a way that the liquid depot is arranged essentially below at least one opening in the direction of gravity.

In a further embodiment of the hydroponic plant production system according to the first aspect of the present invention, the first part of the attachment mechanism is at least partially provided in the carrier element through a through hole having a diameter profile adapted to the plant holder and having a first diameter on the fluid flow contour side of the carrier element and a second diameter on the opposite side of the carrier element, and the second part of the fastening mechanism has a first and a second collar contour for abutment against the carrier element.

The first diameter can be smaller than the second diameter, and a circumference of the first collar contour can also be smaller than a circumference of the second collar contour. The circumference of the first collar contour and the circumference of the second collar contour can be designed such that after insertion, wherein the insertion can take place from the opposite side, in particular the outer side, in the direction of the side with the fluid flow contour, in particular the inner side, of the plant holder into the through hole, the first collar contour surrounds the hole in the inner side and the second collar contour surrounds the hole in the outer side of the carrier element. After attaching the plant holder to the carrier element, the first collar contour can remain in a cavity of a panel-shaped carrier element, and the second collar contour can remain outside the carrier element.

The distance between the first collar contour and the second collar contour can be adapted to the carrier element in such a way that the two collar contours prevent the plant holder from being pushed completely through the hole passing through the carrier element. At least one opening in the plant holder can be located on a part of the plant holder that has been pushed completely through the carrier element after attachment to the carrier element and remains outside the carrier element. In the case of a tower-like structure of the hydroponic plant production system, at least one opening of the attached plant holder can therefore be arranged completely inside the tower-like structure. The dimensions of the hole passing through the carrier element can generally be such that the attached plant holder can be fastened in the carrier element with an essentially precise fit and cannot be pushed completely through the hole.

In a further embodiment of the hydroponic plant production system according to the first aspect of the present invention, the second part of the fastening mechanism comprises two wing elements that attach the attached plant holder to the side of the fluid flow contour carrier element, wherein the fastening mechanism is configured to provide snapping of the plant holder to the carrier element.

The two wing elements can be located on a part of the plant holder that has been pushed completely through the carrier element for attaching the plant holder to the carrier element and remains outside the carrier element after attachment. The two wing elements can be located on opposite parts of the plant holder, wherein a distance between these two opposite parts can be designed in such a way that two wing elements are bent in the direction of the plant holder when they are pushed through the hole in the inside of a carrier element and fold back again after being pushed through, thus fixing the plant holder to the carrier element. The carrier element can have two latching structures that correspond to the shape of two wing elements and into which two wing elements can latch in order to make it more difficult for the inserted plant holder to rotate.

In a further embodiment of the hydroponic plant production system according to the first aspect of the present invention, the second part of the fastening mechanism comprises an inclined contour between the first and second collar contours, wherein the inclined contour additionally forms a sealing element within a second cavity of the separated cavities.

Liquid located on the side with the fluid flow contour can, for example, penetrate into a second cavity of a panel-shaped carrier element due to minor fit inaccuracies between the plant holder and the carrier element, or more generally penetrate into the second cavity due to leakage, in particular via the capillary effect. The inclined contour can extend diagonally from the outside to the inside through the through hole and act as a sealing element and also form a support surface on which the outside of the carrier element can touch the attached plant holder.

In a further embodiment of the hydroponic plant production system according to the first aspect of the present invention, the carrier elements and the plant holder can be removed individually without tools by tilting, pulling or pushing movements, and/or the carrier elements and the plant holder are designed as injection-molded parts and/or as extrusion parts.

The hydroponic plant production system can thus be assembled, converted and disassembled in a simple manner. Two wing elements, which can provide a snap-in of the plant holder on the carrier element, can be constructed in such a way that tilting the plant holder in the direction of the head part, i.e. upwards, enables the snap-in to be released.

According to a second aspect of the present invention, the invention relates to a plant holder for attachment to a carrier element of a hydroponic plant production system, wherein the plant holder comprises: (i) a liquid depot, (ii) a second part of a fastening mechanism adapted to interact with a first part of a fastening mechanism of a carrier element, and (iii) at least one opening through which excess liquid in the liquid depot can be drained.

In one embodiment of the plant holder according to the second aspect of the present invention, the second part of the fastening mechanism has a first and a second collar contour for abutment against the carrier element, and/or the second part of the fastening mechanism has two wing elements which are designed for snapping the plant holder onto the carrier element.

According to a third aspect of the present invention, the invention relates to a carrier element of a hydroponic plant production system, wherein the carrier element comprises at least a first part of an fastening mechanism for attaching at least one plant holder to the carrier element.

In one embodiment of the carrier element according to the third aspect of the present invention, the carrier element is panel-shaped and has at least one cavity, wherein at least one cavity extends continuously along a longitudinal axis of the carrier element.

In a further embodiment of the carrier element according to the third aspect of the present invention, the panel-shaped carrier element has at least two separate cavities, wherein an insulating material is arranged within a first cavity of the separated cavities and/or wherein the first cavity is designed for the passage of a gas and/or wherein a second cavity of the separated cavities is designed for the passage of a liquid.

In a further embodiment of the carrier element according to the third aspect of the present invention, the panel-shaped carrier element has a fluid flow contour on one side, and the panel-shaped carrier element has at least two sealing lips extending completely along the longitudinal axis, and the first part of the fastening mechanism has a through hole in the carrier element, the diameter profile of which is adapted to the plant holder and which has a first diameter on the side of the carrier element with fluid flow contour and a second diameter on the opposite side of the carrier element.

In an alternative embodiment of the carrier element according to the third aspect of the present invention, the panel-shaped carrier element has only one sealing lip extending completely along the longitudinal axis.

Further advantageous embodiments and combinations of features of the invention result from the following detailed description and the entirety of the patent claims.

### BRIEF DESCRIPTION OF THE DRAWINGS

The drawings used to illustrate the exemplary embodiment show:

FIG. 1 shows a hydroponic plant production system with a tower-like support structure.

FIG. 2 shows a section of a carrier element and a plant holder.

FIG. 3 shows views of a plant holder from different perspectives.

FIG. 4 shows a section of a carrier element with sealing lips.

FIG. 5 shows a carrier element with attached plant holder.

FIG. 6 shows a distribution device and a section of a head part.

FIG. 7 shows a hydroponic plant production system with a tower-like support structure with an intermediate part.

In principle, the identical parts are marked with identical reference signs in the figures.

### DETAILED DESCRIPTION OF THE EMBODIMENTS

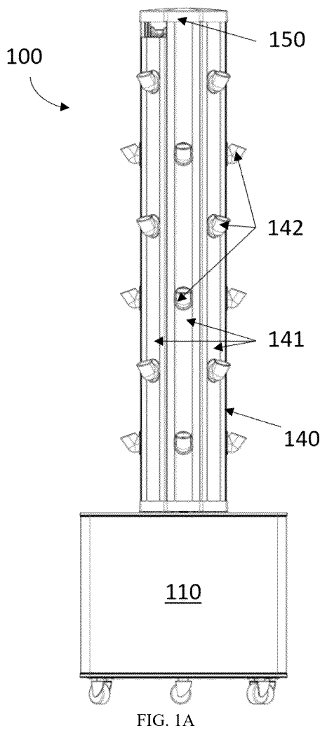

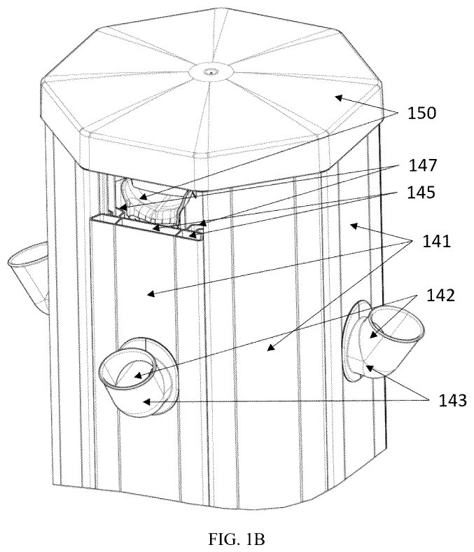

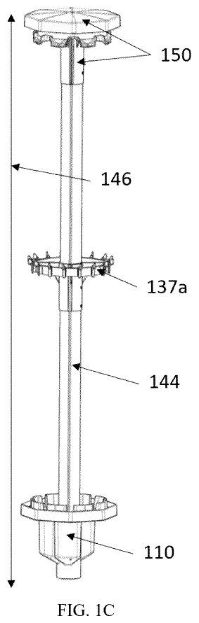

FIG. 1 shows a hydroponic plant production system with a tower-like support structure, wherein FIG. 1A shows an overall view of the hydroponic plant production system from the outside, FIG. 1B shows the upper part of FIG. 1A enlarged and FIG. 1C shows a representation of the additional (primary) support elements.

As shown in FIG. 1A, the hydroponic plant production system 100 comprises a base portion 110, a support structure 140 comprising carrier elements 141, a head part 150 and plant holders 142 attached to the carrier elements 141. For illustrative purposes, a carrier element 141 is cut open in the upper region of FIG. 1A in the vicinity of the head part 150, wherein the corresponding region of the hydroponic plant production system is shown enlarged in FIG. 1B.

As suggested in FIG. 1B, the head part 150 comprises an upper closure which prevents splash water from penetrating to the outside and a distribution device (not shown) with funnel-shaped feed pipes which are designed to feed liquid to the inside of the carrier elements 141. The upper closure is designed so that the carrier elements 141 can be positioned on the head part 150. The carrier elements 141 are panel-shaped and comprise cavities 145 (the cut-away carrier element 141 in FIG. 1B comprises three cavities). The carrier elements 141 also have sealing lips 147 which, by interacting with sealing lips of adjacent carrier elements 141, are designed to at least partially seal connecting regions of adjacent carrier elements 141. A plant holder 142 attached to a carrier element 141, which is supported by the carrier element 141, is attached to the carrier element 141 in such a way that the plant holder 142 receives liquid from the inside of the carrier element 141 and stores it at least temporarily in a liquid depot 143. Roots of a plant inserted in the plant holder 142 can draw liquid from the liquid depot 143.

As shown in FIG. 1C, the hydroponic plant production system comprises a feed pipe 144 between the base part 110 and the head part 140, through which fluid is conveyed from the base part 110 to the head part 150. The feed pipe 144 can be designed as a double pipe, which has two extrusion profiles that are pushed into one another. The outer pipe of the feed pipe 144 can act as a support element and hold the tower-like hydroponic plant production system, and liquid can be transported through the inner pipe of the feed pipe 144. A rim 137a attached to the feed pipe 144 can serve to hold the carrier elements 141, wherein the carrier elements 141 can have corresponding receiving openings 137b for this purpose (not shown). The part of the base part 110 shown in FIG. 1C serves to position the carrier elements 141 and provides a connection for the feed pipe 144 in order to convey liquid from a tank in the base part 110 into the feed pipe 144. Furthermore, the part of the base part 110 shown in FIG. 1C is also an interface, in particular comprising a gear rim, for a rotation of the hydroponic plant production system, i.e. the tower-like support structure 140 can be rotated about its longitudinal axis 146.

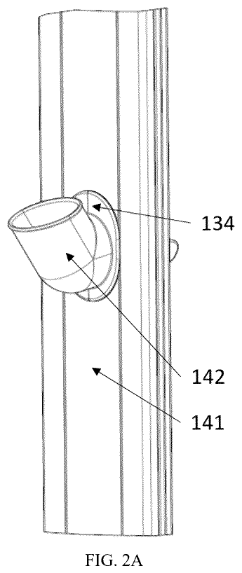

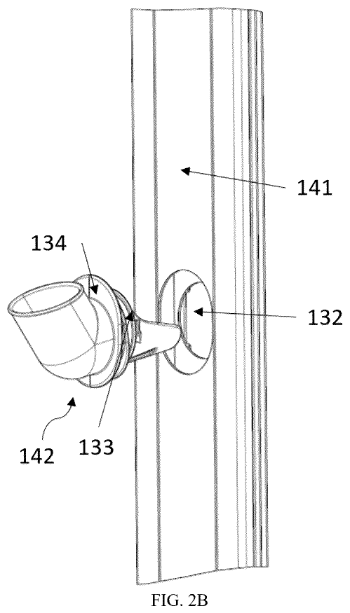

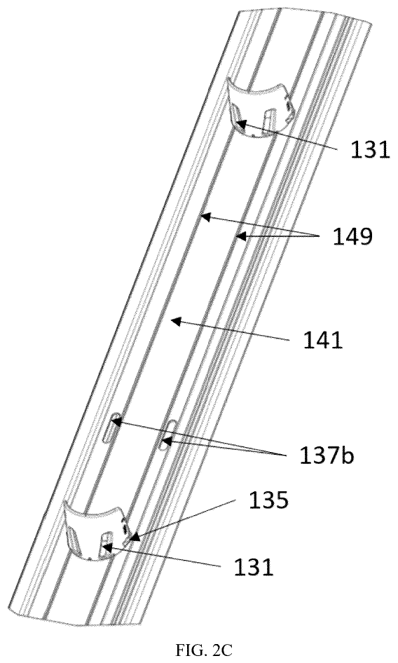

FIG. 2 shows a section of a carrier element 141 and a plant holder 142. The plant holder 142 has a first 133 and a second 134 collar contour (visible in FIG. 2B), wherein the second collar contour 134 in the case of the attached plant holder 142 as shown in FIG. 2A lying flat on an outer side of the support element 141. As can be seen in FIG. 2B, the carrier element 141 has a through hole 132 through which the plant holder 142 is pushed. FIG. 2C shows a top view of an inner side of the carrier element 141 with two plant holders 142 attached thereto. The attached plant holders are each fixed to the carrier element 141 by means of two wing elements 135, wherein two wing elements 135 snap into place after the plant holder 142 has been inserted through the through hole. On the inside of the carrier element 141 there is a fluid flow contour 149, which guides fluid on the inside of the carrier element 141. The fluid flow contour 149 comprises two ribs that guide fluid exiting through openings 131 in the plant holder to a lower-lying plant holder 142. The openings 137b shown in FIG. 2C serve to hold the carrier element 141 on a rim 137a, which is attached to the feed pipe 144.

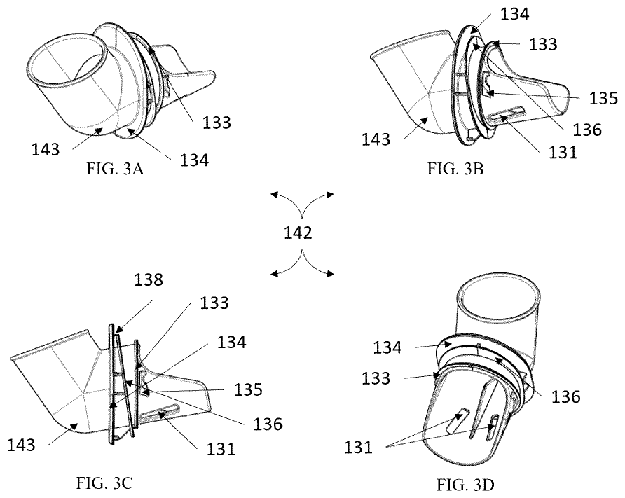

FIG. 3 shows views of a plant holder 142 from different perspectives. The plant holder 142 has a liquid depot 143, a first 133 and second 134 collar contour, an inclined contour 136, two wing elements 135 and two openings 131. At a connection point 138 between the inclined contour 136 and the second collar contour 134, a part of the carrier element 141 can contact the inserted plant holder 142. As shown in FIG. 3d, two openings 131 are arranged at an angle to the outside so that an overflow from the liquid depot 143 can correspond to an amount of water supplied and can be passively controlled. The central rib visible in FIG. 3d between two openings 131 serves to hold a substrate inserted into the plant holder 142, into which a plant can be inserted, in position and to prevent it from slipping through the plant holder 142.

The two, in particular laterally arranged, wing elements 135 of the plant holder 142 are constructed in such a way that they fix a plant holder 142 attached to the carrier element 141 to the carrier element 141 by snapping in. In particular, two wing elements 135 are designed in such a way that tilting the plant holder 142 upwards, i.e. in the direction of the head part 150, enables the snap connection to be released easily. As shown in FIG. 3B and FIG. 3C, the plant holder 142 also has further ribs 129 which distance the inclined contour 136 from the second collar contour 134 and also serve to position the plant holder 142 in the carrier element 141.

Leakage of a liquid into an externally visible area of the hydroponic plant production system, wherein the liquid leaks into a cavity 145 of the carrier element 141, in particular due to a capillary effect at a transition between the inner side of the carrier element and the first collar contour 133, is prevented by the inclined contour 136, which directs the liquid in the cavity 145 back to a wall of the inner side of the carrier element 141 adjacent to the cavity 145. The plant holder 142 is designed such that the liquid depot 143 is located below the openings 131, creating a liquid reservoir, in particular with a capacity of 3 ml, which can be flushed with each watering cycle. The liquid depot 143 can be used to continuously supply the roots of an inserted plant with liquid, i.e. over a period of time.

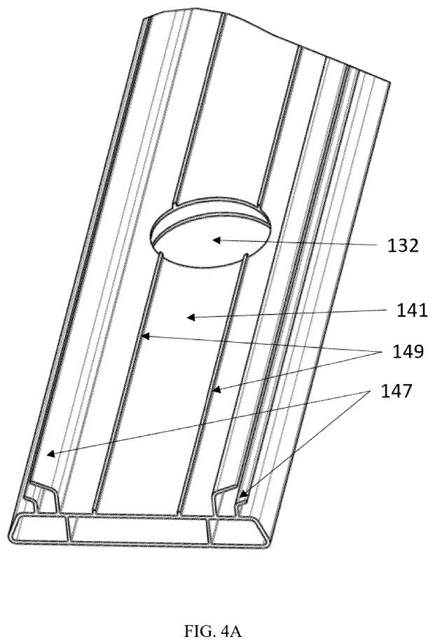

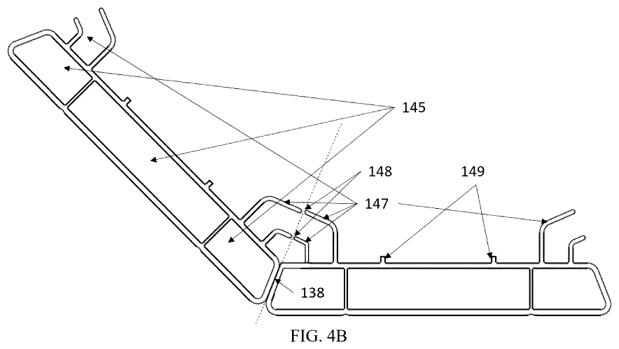

FIG. 4 shows a section of a carrier element with sealing lips. The carrier element shown in FIG. 4a has three cavities 145, wherein air, carbon dioxide or other gases can be transported through two lateral cavities 145 and wherein the central cavity 145 is designed to discharge leakage water. The carrier element 141 can have, in particular at the level of a through hole 132 in which a plant holder 142 is attached to the carrier element 141, at least one additional opening on the outside (not shown) in the region of the lateral cavities 145, through which the gas in the lateral cavities 145 can partially leave the same. In this way, a plant placed in the plant holder 142 can be supplied with gases or cooled by supplied air, wherein this can promote plant growth.

There are four bent sealing lips 147 on the inside of a carrier element 141 shown in FIG. 4A. As shown in FIG. 4B, a sealing effect is provided by an interaction of sealing lips 147 of the adjacent carrier elements 141. Adjacent carrier elements 141 adjoin each other at an interface 139. As can be seen in FIG. 4B with the aid of a sealing plane extending through the interface 139 and through two sealing gaps 148 and shown as a dashed line, the interface 139 is protected by the sealing lips 147 in such a way that splash water from an interior of the hydroponic plant production system of tower-like design can at most penetrate as far as the interface 139 if the splash water moves substantially within the sealing plane. The two sealing lips 147 of adjacent carrier elements 141 comprise two sealing chambers. Since the sealing lips 147 extend along the entire longitudinal axis of the carrier element, splash water that enters the sealing chambers is directed downwards in the sealing chambers to the base part 110. A dimension of two sealing gaps 148 is preferably selected such that little liquid is allowed through the sealing gap and that at the same time an exchange of air can take place through the sealing gap 148.

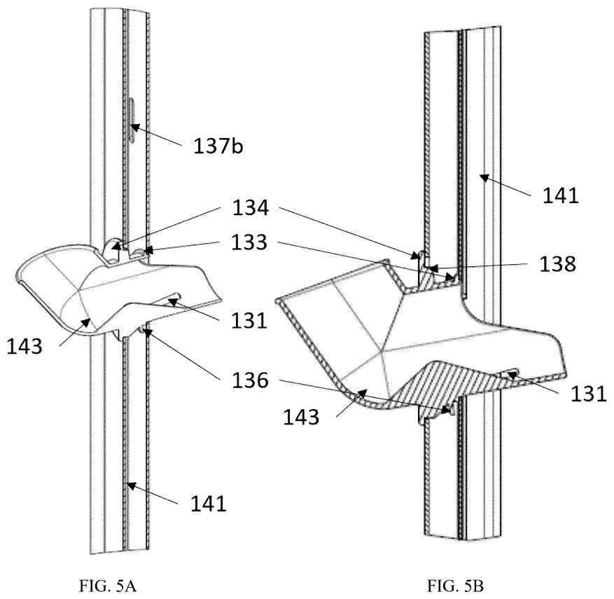

FIG. 5 shows a carrier element with attached plant holder. FIG. 5A shows a top view of the outside of the carrier element 141, wherein the carrier element 141 and the attached plant holder 142 are cut open in the middle so that part of the inside of the carrier element and the plant holder is visible. The two collar contours 133,134, an opening 131 of the two openings 131, the liquid depot 143 and a part of the inclined contour 136 are visible. In the section through the carrier element shown in FIG. 5B, the two collar contours 133,134 and the indented contour 136 are visible. At the point of contact between the first collar contour 133 and the carrier element 141, the liquid may leak into the cavity 145, wherein the inclined contour 136 prevents the infiltrated liquid from exiting the cavity 145 towards an outer region of the tower-like hydroponic plant production system.

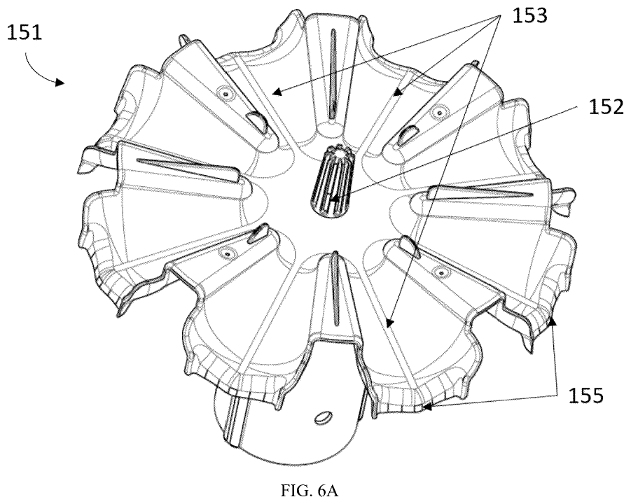

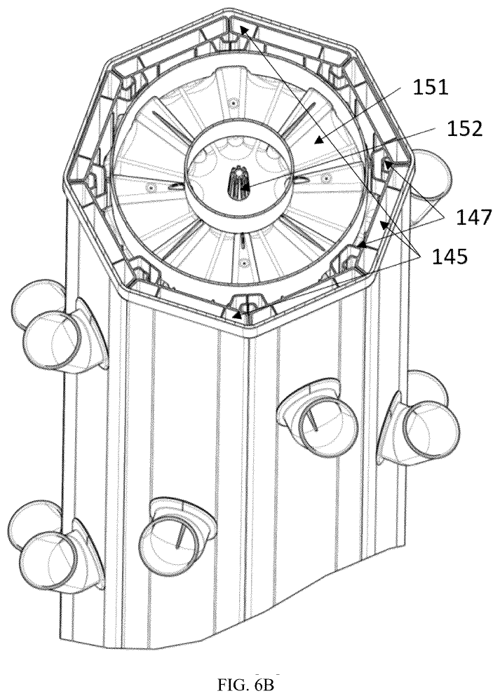

FIG. 6 shows a distribution device and a section of a head part with the upper closure removed (shown in FIG. 1A and FIG. 1B). The distribution device 151 is designed in such a way that it feeds liquid evenly to the carrier elements 141. Water is fed via a central nozzle 152, which has lateral slots, to feed lines 153 descending from the nozzle. The feed lines 153 are each symmetrical, wherein a lowest point of the respective feed line 153 is located at any distance from the nozzle 152 in the center of the respective feed line 153. Liquid is thus first fed through the center of the respective feed lines 153, and only for larger quantities of liquid, the liquid moves into the higher lateral areas of the feed lines 153. The sections of the feed lines 153 adjacent to the inner sides of the carrier elements 141 are angled, i.e. the central area of each feed line 153 comes closer to the inner side of the carrier elements than the areas of the respective feed line 153 that are more lateral to it: thus, even with a small amount of liquid, the liquid in the middle of the inner sides of the carrier elements is directed downwards in the direction of the attached plant holders and the base part 110. At a contact point 155 of the respective feed lines 153, the distribution device can touch the insides of the carrier elements 141.

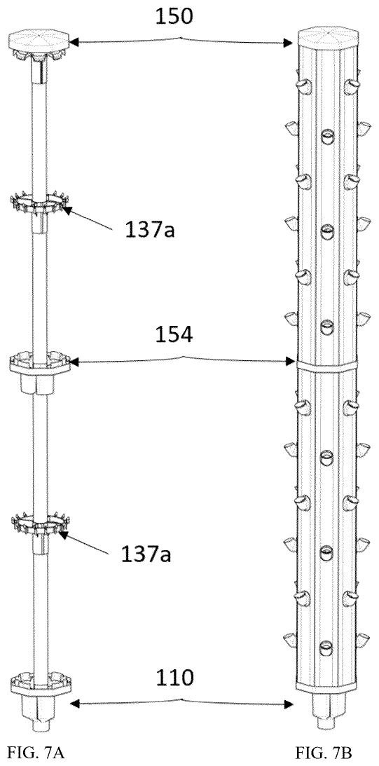

FIG. 7 shows a hydroponic plant production system with a tower-like support structure with an intermediate part. FIG. 7A basically corresponds to FIG. 1C, wherein an intermediate part 154 is shown in FIG. 7A in addition to FIG. 1C. As shown in FIG. 7B, a first part of carrier elements may extend from the base part 110 to the intermediate part 154 and a second part of carrier elements may extend from the intermediate part 154 to the head part 150, wherein the hydroponic plant production system shown is further configured such that fluid flows from the head part 150 to the base part 110 along the inner sides of the carrier elements, i.e., the intermediate part 154 is designed such that liquid is guided from the inner sides of the carrier elements of the second part of carrier elements to the inner sides of the carrier elements of the first part of carrier elements in the region of the intermediate part 154.

1. A hydroponic plant production system, comprising: a base part, a head part, a support structure comprising at least two carrier elements, wherein the carrier elements are individually removably arranged between the base part and the head part and each comprise at least a first part of a fastening mechanism, which is at least partially formed as a hole through the carrier element, for attaching at least one plant holder, and at least one plant holder comprising a second part of the fastening mechanism for attaching the plant holder to a carrier element such that the plant holder is individually removably attached to the carrier element by interaction between the first part and the second part of the fastening mechanism.

2. The hydroponic plant production system according to claim 1, wherein the support structure is formed as a tower-like structure, wherein the carrier elements are each panel-shaped and have at least one cavity, wherein at least one cavity extends continuously along a longitudinal axis, which extends in particular from the base part to the head part, of the respective panel-shaped carrier element, wherein the panel-shaped carrier elements each comprise at least two separated cavities.

3. (canceled)

4. (canceled)

5. (canceled)

6. (canceled)

7. (canceled)

8. The hydroponic plant production system according to claim 2, wherein an insulating material is arranged within a first cavity of the separated cavities by at least one panel-shaped carrier element and/or wherein the first cavity is designed for supplying a gas to the plant holder.

9. The hydroponic plant production system according to claim 2, wherein a first panel-shaped carrier element and a second panel-shaped carrier element of the panel-shaped carrier elements each comprise at least two sealing lips extending completely along the longitudinal axis, wherein the respective at least two sealing lips of the first and second panel-shaped carrier element adjoin one another at a sealing gap and are spaced apart from one another in such a way that only gaseous media, in particular air, can flow through the sealing gap.

10. The hydroponic plant production system according to claim 2, wherein the panel-shaped carrier elements each have a fluid flow contour on a side aligned in particular with an interior of the tower-like structure.

11. The hydroponic plant production system according to claim 1, wherein the head part comprises a distribution device which is designed to guide the liquid to the carrier elements, in particular to the sides of the carrier elements with the fluid flow contour.

12. The hydroponic plant production system according to claim 11, wherein the distribution device comprises funnel-like feed lines, which slope down from a center point, to the carrier elements.

13. The hydroponic plant production system according to claim 1, wherein the support structure comprises additional support elements.

14. (canceled)

15. The hydroponic plant production system according to claim 1, wherein the fastening mechanism is configured such that an excess liquid in the liquid depot is dischargeable through at least one opening of the attached plant holder to the side of the carrier element with fluid flow contour.

16. The hydroponic plant production system according to claim 1, wherein the first part of the fastening mechanism at least partially passes through a through hole whose diameter profile is adapted to the plant holder and which has a first diameter on the side of the carrier element with fluid flow contour and a second diameter on the opposite side of the carrier element, is provided in the carrier element, and wherein the second part of the fastening mechanism has a first and a second collar contour for abutment against the carrier element.

17. The hydroponic plant production system according to claim 1, wherein the second part of the fastening mechanism comprises two wing elements that attach the attached plant holder to the side of the carrier element with the fluid flow contour, wherein the fastening mechanism is configured to provide snapping of the plant holder to the carrier element.

18. The hydroponic plant production system according to claim 16, wherein the second part of the fastening mechanism comprises an inclined contour between the first and second collar contours, wherein the inclined contour additionally forms a sealing element within a second cavity of the separated cavities.

19. The hydroponic plant production system according to claim 1, wherein the carrier elements and the plant holder can be removed individually without tools by tilting, pulling or pushing movements, and/or wherein the carrier elements and the plant holder are designed as injection-molded parts and/or as extrusion parts.

20. (canceled)

21. (canceled)

22. A carrier element for attachment to a hydroponic plant production system according to claim 1, wherein the carrier element comprises at least a first part of a fastening mechanism, which is at least partially formed as a hole passing through the carrier element, for attaching at least one plant holder to the carrier element, wherein the carrier element is panel-shaped and has at least one cavity, wherein the at least one cavity extends continuously along a longitudinal axis of the carrier element, wherein the panel-shaped carrier element has at least two separated cavities, wherein an insulating material is arranged within a first cavity of the separated cavities and/or wherein the first cavity is designed for the passage of a gas and/or wherein a second cavity of the separated cavities is designed for the passage of a liquid.

23. (canceled)

24. (canceled)

25. The carrier element according to claim 22, wherein the panel-shaped carrier element has a fluid flow contour on one side, and wherein the panel-shaped carrier element has at least two sealing lips extending completely along the longitudinal axis, and wherein the first part of the fastening mechanism has a through hole in the carrier element, the diameter profile of which is adapted to the plant holder and which has a first diameter on the side of the carrier element with fluid flow contour and a second diameter on the opposite side of the carrier element.

26. The hydroponic plant production system according to claim 8, wherein a first panel-shaped carrier element and a second panel-shaped carrier element of the panel-shaped carrier elements each comprise at least two sealing lips extending completely along the longitudinal axis, wherein the respective at least two sealing lips of the first and second panel-shaped carrier element adjoin one another at a sealing gap and are spaced apart from one another in such a way that only gaseous media, in particular air, can flow through the sealing gap.

27. The hydroponic plant production system according to claim 9, wherein the panel-shaped carrier elements each have a fluid flow contour on a side aligned in particular with an interior of the tower-like structure.

28. The hydroponic plant production system according to claim 2, wherein the head part comprises a distribution device which is designed to guide the liquid to the carrier elements, in particular to the sides of the carrier elements with the fluid flow contour.

29. The hydroponic plant production system according to claim 8, wherein the head part comprises a distribution device which is designed to guide the liquid to the carrier elements, in particular to the sides of the carrier elements with the fluid flow contour.

30. The hydroponic plant production system according to claim 9, wherein the head part comprises a distribution device which is designed to guide the liquid to the carrier elements, in particular to the sides of the carrier elements with the fluid flow contour.
